(19) United States
(12) Patent Application Publication
(10) Pub. No.: US 2012/0093517 A1
(43) Pub. Date: Apr. 19, 2012

(54) CELL DESIGN AND MOBILITY SUPPORT FOR VISIBLE LIGHT COMMUNICATION

(75) Inventors: Sridhar Rajagopal, Plano, TX (US); Doyoung Kim, Seokwoo dong hwaseung city (KR); Taehan Bae, Seoul (KR); Jaeseung Son, Suwon-si (KR)

(73) Assignee: Samsung Electronics Co., Ltd., Suwon-si (KR)

(21) Appl. No.: 13/053,665

(22) Filed: Mar. 22, 2011

Related U.S. Application Data
(60) Provisional application No. 61/393,777, filed on Oct. 15, 2010.

(51) Int. Cl. H04B 10/00

(52) U.S. Cl. 398/130

(57) ABSTRACT

A method and apparatus for supporting mobility of VLC (visible light communication) devices in a VLC network. A method includes transmitting data to a VLC device at a first cell. The method also includes searching for a response from the VLC device at a second cell that is adjacent to the first cell. The method further includes receiving the response from the VLC device at the second cell. The method also includes determining a mobility of the VLC device based on a change in communication from the first cell to the second cell.

### CROSS-REFERENCE TO RELATED APPLICATION(S) AND CLAIM OF PRIORITY

The present application is related to U.S. Provisional Patent Application No. 61/393,777, filed Oct. 15, 2010, entitled “CELL DESIGN AND MOBILITY SUPPORT FOR VISIBLE LIGHT COMMUNICATION”. Provisional Patent Application No. 61/393,777 is assigned to the assignee of the present application and is hereby incorporated by reference into the present application as if fully set forth herein. The present application hereby claims priority under 35 U.S.C. §119(e) to U.S. Provisional Patent Application No. 61/393,777.

### TECHNICAL FIELD OF THE INVENTION

The present application relates generally to visible light communication and, more specifically, to a cell design to support mobility in visible light communication.

### BACKGROUND OF THE INVENTION

Visible light communication (VLC) is a new technology for short-range optical wireless communication using visible light in optically transparent media. This technology provides access to several hundred terahertz (THz) of unlicensed spectrum. VLC is immune to the problems of electromagnetic interference and non-interference associated with radio frequency (RF) systems. VLC provides an additional level of security by allowing a user to see the transmission of data across the communication channel. Another benefit of VLC is that it augments and complements existing services (such as illumination, display, indication, decoration, etc.) from existing visible-light infrastructures. A VLC network is any network of two or more devices that engage in VLC.

FIG. 1 depicts the full electromagnetic frequency spectrum, and a breakout of the wavelengths occupied by visible light. The visible light spectrum extends from approximately 380 to 780 nm in wavelength, which corresponds to a frequency range of approximately 400 to 790 THz. Since this spectrum is large and can support light sources with multiple colors, VLC technology can provide a large number of channels for communication.

### SUMMARY OF THE INVENTION

For use in a visible light communication (VLC) network, a method for determining mobility of VLC devices is provided. The method includes transmitting data to a VLC device at a first cell. The method also includes searching for a response from the VLC device at a second cell that is adjacent to the first cell. The method further includes receiving the response from the VLC device at the second cell. The method also includes determining a mobility of the VLC device based on a change in communication from the first cell to the second cell.

For use in a visible light communication (VLC) network, a VLC coordinator configured to communicate with and determine mobility of VLC devices is provided. The VLC coordinator includes a plurality of optical sources, at least one of the optical sources configured to transmit data to a VLC device at a first cell. The VLC coordinator also includes a device management entity (DME) coupled to a physical (PHY) layer, the DME configured to search for a response from the VLC device at a second cell that is adjacent to the first cell. The VLC coordinator further includes at least one photodetector configured to receive the response from the VLC device at the second cell. The DME is configured to determine a mobility of the VLC device based on a change in communication from the first cell to the second cell.

For use in a visible light communication (VLC) network, a method for supporting mobility of VLC devices is provided. The method includes transmitting a beacon frame to a plurality of VLC devices in a macrocell, the beacon frame transmitted during a beacon period of a superframe. The method also includes dividing the macrocell into a plurality of cells based on a location of each of the VLC devices. The method further includes allocating a transmission time slot for each VLC device. The method also includes, for each VLC device, transmitting data to the VLC device during the time slot allocated to the VLC device, the data transmitted only in a cell associated with the VLC device.

For use in a visible light communication (VLC) network, a VLC coordinator configured to support mobility of VLC devices is provided. The VLC coordinator includes a plurality of optical sources arranged in a macrocell, each optical source configured to transmit a beacon frame to a plurality of VLC devices in the macrocell, the beacon frame transmitted during a beacon period of a superframe. The VLC coordinator also includes a physical (PHY) layer configured to divide the optical sources in the macrocell into a plurality of cells based on a location of each of the VLC devices. The VLC device further includes a device management entity (DME) coupled to the PHY layer, the DME configured to allocate a transmission time slot for each VLC device. For each VLC device, at least one of the optical sources is configured to transmit data to the VLC device during the time slot allocated to the VLC device, the at least one optical source being part of a cell associated with the VLC device

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 depicts the full electromagnetic frequency spectrum, and a breakout of the wavelengths occupied by visible light;

FIG. 2 illustrates a graphical representation of the layers of a Visible Personal Area Network (VPAN) device architecture, according to an embodiment of the present disclosure;

FIG. 3 illustrates examples of physical and logical mobility in VLC according to an embodiment of the present disclosure;

FIG. 4 illustrates a cell configuration for VLC mobility, according to an embodiment of the present disclosure;

FIG. 5 illustrates mobility support for a device that moves through multiple cells, according to an embodiment of the present disclosure;

FIG. 6 illustrates a configuration of a superframe for mobility support, according to an embodiment of the present disclosure; and

FIG. 7 illustrates a procedure for establishing the size and location of each cell according to an embodiment of the present disclosure.

### DETAILED DESCRIPTION OF THE INVENTION

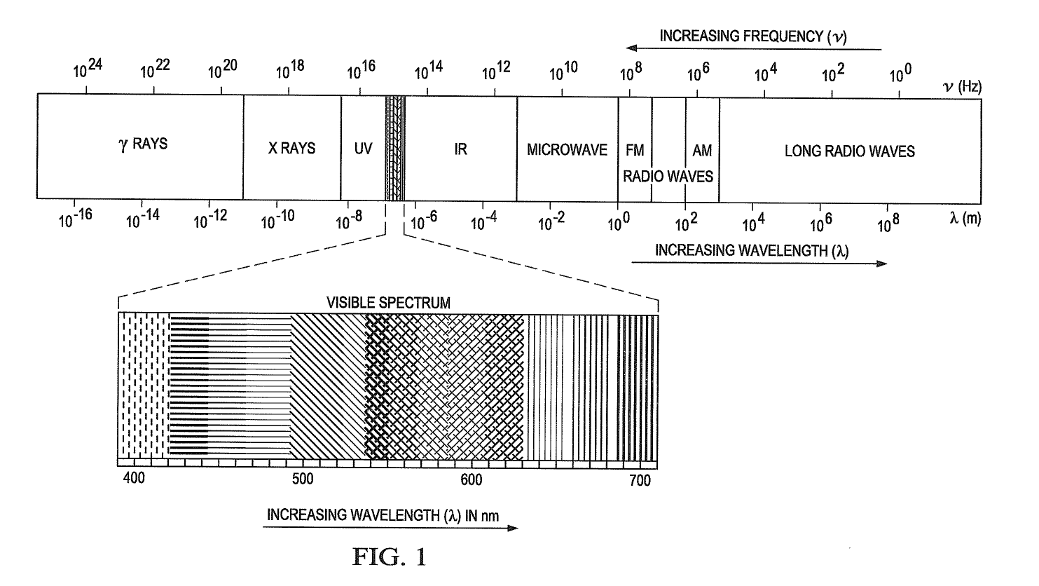

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged visible light communication network.

The following documents and standards descriptions are hereby incorporated into the present disclosure as if fully set forth herein:

IEEE 802.15.7 Standard document, found at the time of filing at http://www.ieee802.org/15/pub/TG7.html;

Larry Taylor, “VLC-Application Category Terms & Mobility”, March 2009, found at the time of filing at https://mentor.ieee.org/802.15/dcn/09/15-09-0205-01-0007-vlc-application-category-terms-mobility.ppt;

Sridhar Rajagopal, Doyoung Kim, “VLC cell mobility clarification”, September 2010, found at the time of filing at https://mentor.ieee.org/802.15/dcn/10/15-10-0693-02-0007-vlc-cell-mobility-clarification.pdf; and

Sridhar Rajagopal, et al., “Samsung, Intel, ETRI and CSUS merged proposal text”, November 2009, found at the time of filing at https://mentor.ieee.org/802.15/dcn/09/15-09-0786-01-0007-15-7-merged-draft-text-etri-samsung-csus-intel.pdf.

The IEEE 802.15.7 Standard document provides standards for the Physical (PHY) and Medium Access Control (MAC) layers architecture in VLC. In accordance with IEEE 802.15.7, VLC architecture is defined in terms of a number of layers and sublayers in order to simplify the standard. Each layer is responsible for one part of the standard and offers services to the higher layers. The interface between the layers serves to define the logical links that are described in this standard.

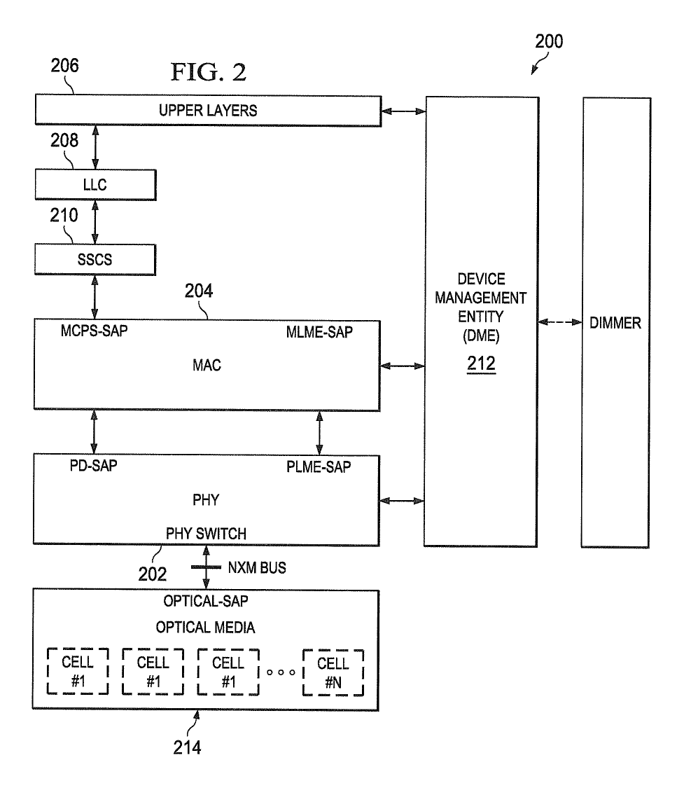

FIG. 2 illustrates a graphical representation of the layers of a Visible Personal Area Network (VPAN) device architecture, according to an embodiment of the present disclosure. As shown in FIG. 2, a VPAN device 200 includes a PHY layer 202, a MAC sublayer 204, upper layers 206, a logical link control (LLC) layer 208, a service-specific convergence sublayer (SSCS) 210, a device management entity (DME) 212, and an optical media layer 214.

PHY layer 202 includes at least one light transceiver, along with its low-level control mechanism. MAC sublayer 204 provides access to the physical channel for all types of transfers. The upper layers 206 include a network layer, which provides network configuration, manipulation, and message routing; and an application layer, which provides the intended function of the device. LLC layer 208 accesses the MAC sublayer through SSCS 210.

As shown in FIG. 2, DME 212 may communicate with the service access point (SAP) of the MAC link management entity (MLME) and PHY layer management entity (PLME) for the purposes of interfacing the MAC and PHY with a dimmer. DME 212 may access certain dimmer related attributes from the MLME and PLME in order to provide dimming information to MAC layer 204 and PHY layer 202. DME 212 may also control the PHY switch using the PLME for selection of the optical sources (e.g., light emitting diodes (LEDs)) and photodetectors.

The PHY switch connects to optical media layer 214 through an interface to the optical SAP. Optical media layer 214 may include a single or multiple optical sources and photodetectors. The IEEE 802.15.7 standard supports three PHY types: PHY I, PHY II, and PHY III. Multiple optical sources and photodetectors are supported in the IEEE 802.15.7 standard for PHY III as well as for VLC cell mobility. The PLME controls the PHY switch in order to select a cell.

The line in FIG. 2 connecting the PHY switch to the optical SAP represents a vector (i.e., a bus). The number of lines in the optical SAP bus is dependent on the number of optical sources, n×m, that are controlled by the PHY, where ‘n’ is the number of cells and ‘m’ is the number of possible independent data streams (e.g., distinct frequency sources) from the PHY. The value of ‘m’ is one (1) for PHY I and PHY II. The value of ‘m’ is three (3) for PHY III. For example, a white LED may be modulating on three different frequencies corresponding to red, green, and blue colors. In this situation, ‘m’ would have a value of three.

The following definitions apply to VLC cell mobility in accordance with the present disclosure:

PHY switch: A switch at the transmission interface between the PHY and the optical SAP, used to send and receive data to and from a single or multiple optical sources and photodetectors in a selective manner.

Cell: A group of one or more optical sources or photodetectors selected by the PHY switch at a given time. In certain embodiments, every optical source or photodetector in the cell operates (e.g., transmits and/or receives data) in unison, and often at the same frequency or frequencies of light.

Macro cell: An aggregate cell formed using all of the cells available at the optical media. The cells in a macro cell may temporarily operate or communicate in unison in order to facilitate device discovery and association.

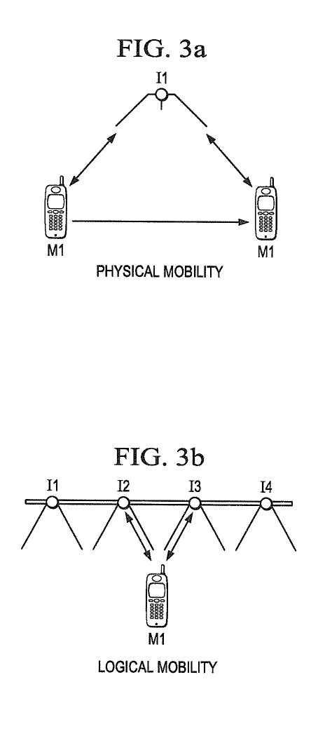

FIG. 3 illustrates examples of physical and logical mobility in VLC according to an embodiment of the present disclosure. As shown in FIG. 3, a VLC device M1 may communicate with a number of infrastructure light sources, represented here by through 14. Examples of infrastructure light sources include overhead ambient light fixtures in a room or building and street illumination lights along streets and highways. Embodiments of the present disclosure are compatible with other light sources as well, including electronically illuminated sign boards, televisions, and video displays.

Mobility in VLC includes two types: physical and logical. FIG. 3(a) shows an example of physical mobility, which occurs when VLC device M1 changes its position due to the movement within the coverage area of infrastructure source I1. In contrast, FIG. 3(b) shows an example of logical mobility, which occurs when VLC device Ml changes its communication link from a link with infrastructure source I2 to one with infrastructure source I3. The change in communication link from one infrastructure source to another (also called “link switching”) may be due to interference or deliberate channel switching.

Since VLC is highly directional, traditional communication system designs that support omni-directional communication and mobility may not be applicable in VLC. Embodiments of the present disclosure provide detailed information on how cells with multiple optical elements can be designed for VLC and how mobility may be supported across these cells. In disclosed embodiments, a coordinator DME (e.g., DME 212) may separate the optical media into multiple cells in order to support applications such as location based services.

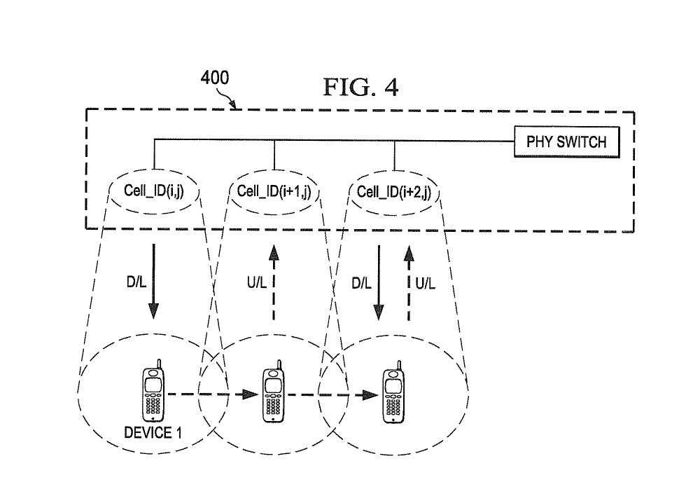

FIG. 4 illustrates a cell configuration for VLC mobility, according to an embodiment of the present disclosure. As shown in FIG. 4, a single coordinator 400 is configured to support mobility of Device 1 as the device moves through multiple cells. The coordinator 400 supports mobility using a PHY switch connected to optical media and controlled by a DME. For ease of explanation, coordinator 400 may represent VPAN device 200 in FIG. 2, and Device 1 may represent VLC device Ml.

Each optical element (e.g., a single LED) in a cell is denoted by cell_ID(i, j) where j is the index of the optical element in the ith cell. In certain embodiments, because all optical elements in a cell operate in unison, it may not be necessary to distinguish between the elements in the cell. Thus, some embodiments of the present disclosure refer to the element index simply as ‘j’. It will be understood, however, that in other embodiments, the value of j may be important for distinguishing between different elements in a cell. The size and the position of the cells in the optical media shown in FIG. 4 may be variable and may be programmed by the DME of coordinator 400. The determination of the actual size and position of optical elements for the cell by a coordinator's DME is not defined in the IEEE 802.15.7 standard.

As shown in FIG. 4, Device 1 moves from cell_ID(i, j) to cell_ID(i+1, j) and then to cell_ID(i+2, j). While Device 1 is in cell_ID(i, j), it receives data from coordinator 400 on the downlink. As Device 1 moves to the next cell, for example, from cell_ID(i, j) to cell_ID(i+1, j), Device 1 may transmit a response (i.e., an acknowledgment frame or CVD (color-visibility-dimming) frame) on the uplink from cell_ID(i+1, j). Thus, coordinator 400 does not receive the expected uplink transmission in cell_ID(i, j). Coordinator 400 then searches for Device 1 through the adjacent cells such as cell_ID(i+1, j) and cell_ID(i−1, j) during the same time slots assigned to Device 1 in the superframe.

The searching process may be terminated if Device 1 is not found within the link timeout period, which can be defined, for example, using a MAC PIB (PHY personal area network information base) attribute macLinkTimeOut. Upon the termination of the searching processing, Device 1 may then be considered to be disassociated from coordinator 400.

Alternatively, through its search, coordinator 400 may detect the response from Device 1 in cell_ID(i+1, j). Based on the reception of the uplink signal in a cell different from the transmission of the downlink signal, coordinator 400 detects the mobility of Device 1. Any other devices present in cell_ID(i, j) may continue communication in the same cell. Similarly, if Device 1 moves to cell_ID(i+2, j) and then stays within the boundaries of cell_ID(i+2, j), both uplink and downlink communication can occur within the single cell cell_ID(i+2, j). In this situation, coordinator 400 detects no further mobility of Device 1.

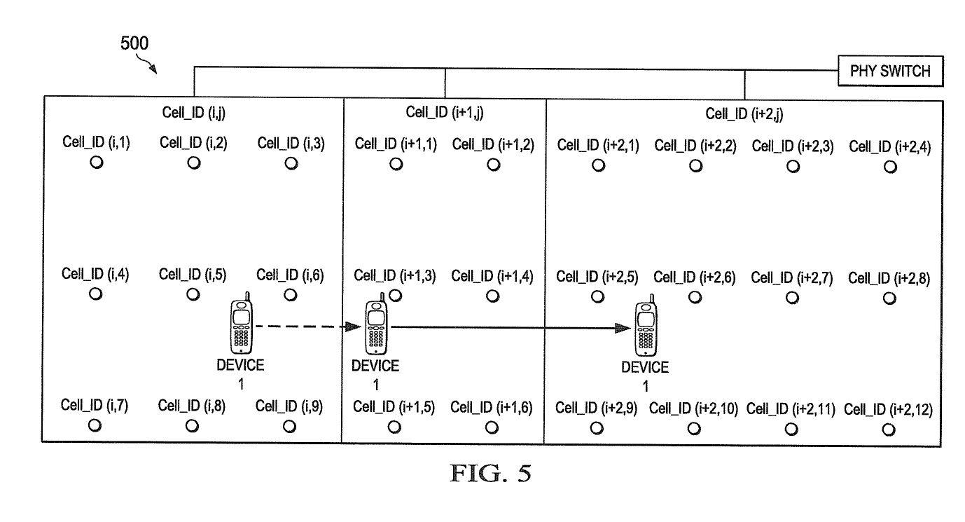

FIG. 5 illustrates mobility support for a device that moves through multiple cells, according to an embodiment of the present disclosure. As shown in FIG. 5, a coordinator 500 is configured to support mobility of Device 1 as the device moves through multiple cells. Cell_ID(i, j) includes nine (9) cells, as indicated by the values one through nine for the ‘j’ index. Similarly, Cell_ID(i+1, j) includes six (6) cells and Cell_ID(i+2, j) includes twelve (12) cells. For ease of explanation, coordinator 500 may represent VPAN device 200 in FIG. 2 or coordinator 400 in FIG. 4.

Coordinator 500 may expand or contract the cell size of one or more the cells in order to provide or enhance coverage for mobility of Device 1. Coordinator 500 may determine a cell size and structure for use in communication with Device 1 upon receiving an uplink transmission from Device 1. Thus, if coordinator 500 can resume communication with the Device 1 in cell_ID(i+1, j), the coordinator DME may set the PHY switch to use cell_ID(i+1, j) for device 1 during the time slots allocated for device 1 and then switch back to cell_ID(i, j) to service any existing devices in cell_ID(i, j) in the remaining time slots.

The determination of the size of each cell may depend on a variety of factors. Where a number of different VLC devices are communicating concurrently with a VPAN device, the VPAN device may want to create smaller cells in order to provide more communication channels. Alternatively, when fewer VLC devices are communicating currently with the VPAN device, and one or more of the VLC devices is moving, the VPAN device may find it beneficial to create fewer, larger cells so the VPAN device does not have to track the movement.

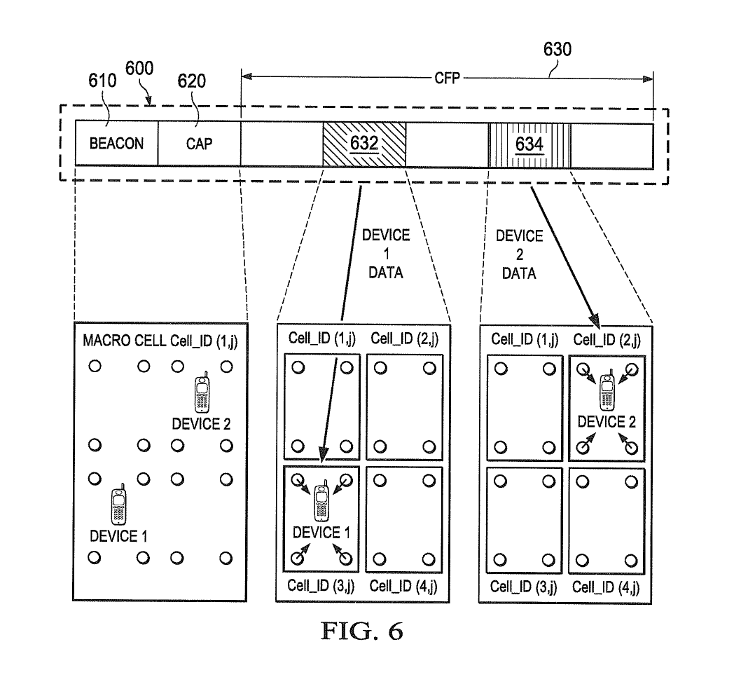

FIG. 6 illustrates a configuration of a superframe for mobility support, according to an embodiment of the present disclosure. As shown in FIG. 6, superframe 600 includes a beacon period 610, a contention access period (CAP) 620, and a contention free period (CFP) 630. CFP 630 includes a number of transmission time slots, including time slot 632 and time slot 634.

In order to support access for new devices through the entire superframe 600, the entire optical media (e.g., optical media 214) is configured to a single macro cell cell_ID(1, j) during beacon period 610 and CAP 620. Beacon period 610 represents the start of superframe 600. During beacon period 610, the coordinator (e.g., VPAN device 200) transmits beacon information on the downlink to any devices (e.g., Device 1 and Device 2) that are in macrocell cell_ID(1, j). During CAP 620, each device in cell_ID(1, j) requests access on the uplink. The coordinator uses the access requests to discover and associate each device.

Once all the devices are discovered and associated, the cell sizes and positions can be determined and the cell structure can be applied to the individual device(s) for communication. For example, in superframe 600, Device 1 and Device 2 are discovered by the coordinator. Time slot 632 is allocated for Device 1 and time slot 634 is allocated for Device 2. The macro cell is divided into four cells: cell_ID(1, j), cell_ID(2, j), cell_ID(3, j), and cell_ID(4, j). Device 1 is associated with cell_ID(3, j) and Device 2 is associated with cell_ID(2, j). Other devices (not shown) may be associated with one of the four cells. During time slot 632, data for Device 1 is transmitted on the downlink from the optical sources in cell_ID(3, j). Likewise, during time slot 634, data for Device 2 is transmitted on the downlink from the optical sources in cell_ID(2, j).

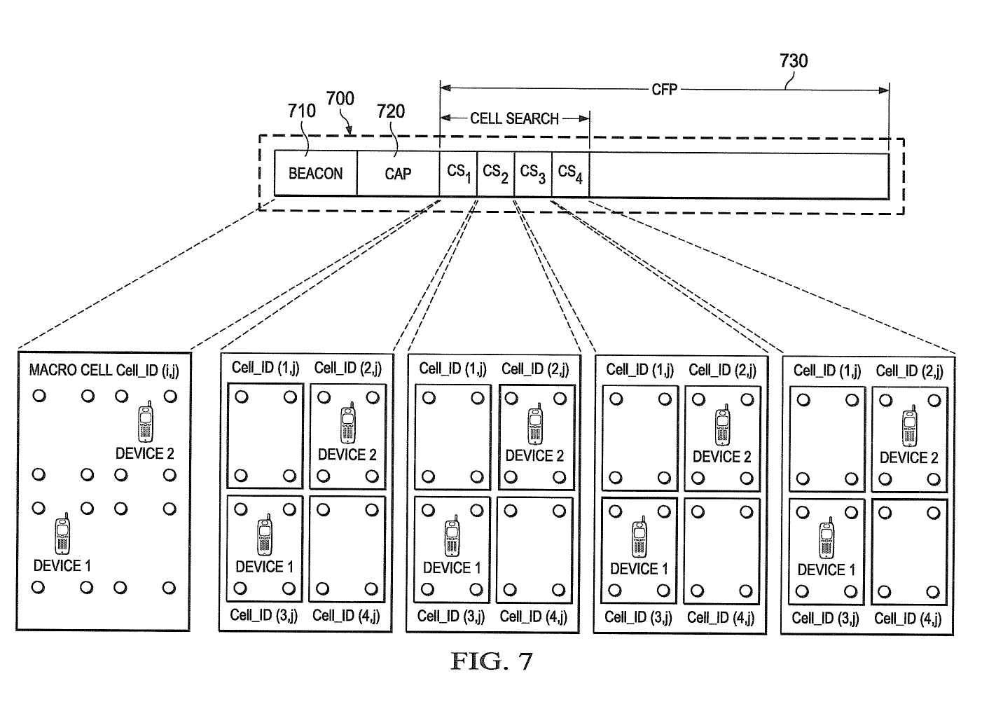

Turning now to FIG. 7, a procedure for establishing the size and location of each cell according to an embodiment of the present disclosure is disclosed. Once a device is associated with a coordinator using the beacon and CAP, the coordinator may establish the size and location of the cell in order to service the new device in the CFP with a smaller cell size.

As shown in FIG. 7, superframe 700 includes a beacon period 710, a contention access period (CAP) 720, and a contention free period (CFP) 730. CFP 730 includes a number of cell search slots CS1 through CS4. The number of cell search slots associated with CFP 730 may be determined by setting a cellSearchLength field in the beacon frame.

Table 1 below illustrates an example format of a beacon frame. The beacon frame includes a superframe specification field and an optional cellSearchLength field. Whether or not the cellSearchLength field is included in the beacon frame is determined by the setting of a cell search enable bit (cellSearchEn) in the superframe specification field, shown in greater detail in Table 2 below. If the cellSearchEn bit is set, the cellSearchLength is transmitted as an additional field in the beacon frame. If the cellSearchEn bit is not set, the beacon frame does not include a cellSearchLength field.

TABLE 1
Beacon frame format

| Octets: | | | | | | | | | |
|---|---|---|---|---|---|---|---|---|---|
| 2 | 1 | 4/10 | 0/5/6/10/14 | 2 | variable | variable | 0/1 | variable | 2 |
| Frame | Sequence | Addressing | Auxiliary | Superframe | GTS | Pending | cellSearchLength | Beacon | FCS |
| Control | Number | fields | Security | Specification | fields | address | | Payload | |
| | | | Header | | | fields | | | |

| | | |
|---|---|---|
| MHR | MSDU | MFR |

TABLE 2
Format of superframe specification field

| Bits: | | | | | | |
|---|---|---|---|---|---|---|
| 0-3 | 4-7 | 8-11 | 12 | 13 | 14 | 15 |
| Beacon | Superframe | Final | Reserved | WPAN | Association | cellSearchEn |
| Order | Order | CAP Slot | | Coordinator | Permit | |

In order to determine the size and location of the cell, the coordinator first sets the cellSearchEn bit indicated in the superframe specification field of the beacon frame. If the cellSearchEn bit is set, the cellSearchLength field is transmitted as an additional field in the beacon frame. If the cellSearchEn bit is set, the coordinator readjusts its superframe GTS allocation to ensure the first cellSearchLength slots of the CFP are allocated for cell size and location search.

FIG. 7 shows a sequential search for four (4) cells, cell_ID(1, j) through cell_ID(4, j). Cell search slots CS1 to CS4 are the four (4) cell search slots corresponding to the four (4) cells. Cell search slots CS1 to CS4 are made available for searching by setting the cellSearchLength field to four (4) and setting the cellSearchEn bit in the beacon frame.

Cell search slots CS1 to CS4 are used as visibility slots by the coordinator and the devices. During slots CS1 to CS4, the coordinator sequentially cycles through the four (4) cells, cell_ID(1, j) through cell_ID(4, j), and transmits CVD frames in all the cells. For example, in slot CS1, the coordinator transmits CVD frames and listens for devices in cell_ID(1, j). The coordinator determines that no devices are in cell_ID(1, j). In slot CS2, the coordinator transmits CVD frames and listens for devices in cell_ID(2, j). The coordinator determines that Device 2 is in cell_ID(2, j). In slot CS3, the coordinator transmits CVD frames and listens for devices in cell_ID(3, j). The coordinator determines that Device 1 is in cell_ID(3, j). In slot CS4, the coordinator transmits CVD frames and listens for devices in cell_ID(4, j). The coordinator determines that no devices are in cell_ID(4, j).

If a device receives a beacon with the cellSearchEn bit set to 1, the device may continuously transmit CVD frames during the cell search slots while also monitoring the CVD frame reception from the coordinator. For example, Device 1 and Device 2 receive a beacon during beacon period 710. Thus, Device 1 and Device 2 continuously transmit CVD frames during the cell search slots CS1 through CS4 while also monitoring the CVD frame reception from the coordinator. The devices note the wavelength quality indicator (WQI) during each of the four (4) slots CS1 through CS4 and report this information back to the coordinator.

In an embodiment, the information is reported back to the coordinator in a mobility notification command. Table 3 below shows an example of a mobility notification command frame. The WQI values (in octets) obtained for the current channel during the cell search is included in the command frame, as indicated by the cellSearchQuality field in Table 3. The number of octets sent is equal to the value of cellSearchLength.

TABLE 3
Mobility notification command

| octets: 7 | 1 | variable |
|---|---|---|
| MHR fields | Command Frame Identifier | cellSearchQuality |

The coordinator makes the determination of the cell sizes and location based on the information from the mobility notification command and its own reception of the CVD frames from each device during the cell search slots.

In another embodiment of the present disclosure, a PHY management service is provided to interface the transport of management commands between the DME and the PHY. A PLME-SWITCH primitive is designed to provide control of the PHY switch from the DME.

The PLME-SWITCH.request primitive request is used by the DME to request that the PHY entity select the switch to enable the appropriate cells in the SW-BIT-MAP. The semantics of the PLME-SWITCH.request primitive are as follows:

| | |
|---|---|
| PLME-SWITCH.request | ( |
| | SW-BIT-MAP, |
| | DIR |
| ) | |

Table 4 below specifies the parameters for the PLME-SWITCH.request primitive.

TABLE 4
PLME-SWITCH.request parameters

| Name | Type | Valid range | Description |
|---|---|---|---|
| SW-BIT-MAP | Vector of | BOOLEAN | One bit for each optical |
| | ‘n’ × ‘m’ | | source or photodetector and |
| | entries | | is dependent on the direction. |
| | | | Setting the k^{th} bit to a “1” |
| | | | brings the corresponding |
| | | | optical source or |
| | | | photodetector into the |
| | | | cell group. ‘n’ is the |
| | | | number of cells and ‘m’ is |
| | | | 1 for PHY I, II and 3 for PHY |
| | | | III |
| DIR | | BOOLEAN | ‘0’ is for TX and ‘1’ is for |
| | | | ‘RX’ |

The PLME-SWITCH.request primitive is generated by the DME and issued to its PLME when the current cell selection is to be changed. On receipt of the PLME-SWITCH.request primitive, the PLME will cause the PHY to attempt to change to the cell.

The PLME-SWITCH.confirm primitive reports the result of a request to change the currently operating cell. The semantics of the PLME-SWITCH.confirm primitive are as follows:

| | |
|---|---|
| PLME-SWITCH.confirm | ( |
| | status |
| | ) |

Table 5 below specifies the parameters for the PLME-SWITCH.confirm primitive.

TABLE 5
PLME-SWITCH.confirm parameters

| Name | Type | Valid range | Description |
|---|---|---|---|
| Status | Enumeration | SUCCESS | The result of the request |
| | | | to change the cell |

The PLME-SWITCH.confirm primitive is generated by the PLME and issued to its DME after attempting to change the cell. On receipt of the PLME-SWITCH.confirm primitive, the DME is notified of the result of its request to change the currently operating cell. If the PHY switch is able to select the new cell, the PHY will issue the PLME-SWITCH.confirm primitive with a status of SUCCESS.

VLC cell design and mobility is an important aspect of VLC system design. Embodiments of the present disclosure allow the possibility of extending VLC communication even when the device is mobile (including either physical or logical mobility).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a visible light communication (VLC) network, a method for determining mobility of VLC devices, the method comprising:
transmitting data from a VLC coordinator to a VLC device at a first cell;
upon a determination that the data transmission is not successful, searching for a response from the VLC device during an expected time slot at a second cell that is adjacent to the first cell;
receiving the response from the VLC device at the second cell; and
determining a mobility of the VLC device based on a change in communication from the first cell to the second cell.

2. The method of claim 1, wherein the mobility of the VLC device comprises one of physical mobility and logical mobility.

3. The method of claim 1, wherein each cell comprises at least one optical source configured to communicate with the VLC device.

4. The method of claim 3, wherein the at least one optical source comprises a plurality of optical sources that transmit same data to the VLC device in unison.

5. For use in a visible light communication (VLC) network, a VLC coordinator configured to communicate with and determine mobility of VLC devices, the VLC coordinator comprising:
a plurality of optical sources, at least one of the optical sources configured to transmit data to a VLC device at a first cell;
a device management entity (DME) coupled to a physical (PHY) layer, the DME configured, upon a determination that the data transmission is not successful, to search for a response from the VLC device during an expected time slot at a second cell that is adjacent to the first cell; and
at least one photodetector configured to receive the response from the VLC device at the second cell;
wherein the DME is configured to determine a mobility of the VLC device based on a change in communication from the first cell to the second cell.

6. The VLC coordinator of claim 5, wherein the mobility of the VLC device comprises one of physical mobility and logical mobility.

7. The VLC coordinator of claim 5, wherein the at least one optical source configured to transmit data to a VLC device at a first cell comprises two or more optical sources that are selected by a PHY switch at a given time.

8. The method of claim 7, wherein the two or more optical sources in each cell transmit same data to the VLC device in unison.

9. For use in a visible light communication (VLC) network, a method for supporting mobility of VLC devices, the method comprising:
transmitting a beacon frame from a VLC coordinator to a plurality of VLC devices in a macrocell, the beacon frame transmitted during a beacon period of a superframe;
providing a contention access period for each VLC device in the macrocell to connect to the VLC coordinator;
dividing the macrocell into a plurality of cells based on a location of each of the VLC devices;
providing a plurality of cell search time slots in the superframe to search for VLC device locations, wherein during each cell search time slot, only one cell of the macrocell is enabled for communication at a given time;
allocating a transmission time slot for each VLC device; and
for each VLC device, transmitting data from the VLC coordinator to the VLC device during the time slot allocated to the VLC device, the data transmitted only in a cell associated with the VLC device.

10. The method of claim 9, further comprising:
during each of the cell search time slots:
transmitting at least one visibility frame from the VLC coordinator at a cell associated with the cell search time slot;
receiving a response comprising a visibility frame transmitted from a VLC device in the cell associated with the cell search time slot; and
determining that the VLC device is located in the cell in which the response from the VLC device was received.

11. The method of claim 9, wherein the macrocell comprises an aggregate cell comprising all optical sources coupled to a physical layer (PHY) switch.

12. The method of claim 9, wherein the number of cell search time slots is determined according to a value in a cellSearchLength field in the beacon frame.

13. The method of claim 9, wherein the transmission time slot allocated to each VLC device is part of a contention free period (CFP) in the superframe.

14. The method of claim 9, wherein the data is transmitted to each VLC device based on a SW-BIT-MAP vector, each bit in the SW-BIT-MAP vector corresponding to a distinct optical source.

15. The method of claim 14, wherein the SW-BIT-MAP vector is a n×m vector, where n is a number of cells and m is a number of distinct data streams.

16. For use in a visible light communication (VLC) network, a VLC coordinator configured to support mobility of VLC devices, the VLC coordinator comprising:
a plurality of optical sources arranged in a macrocell, each optical source configured to transmit a beacon frame to a plurality of VLC devices in the macrocell, the beacon frame transmitted during a beacon period of a superframe;
a physical (PHY) layer configured to divide the optical sources in the macrocell into a plurality of cells based on a location of each of the VLC devices; and
a device management entity (DME) coupled to the PHY layer, the DME configured to allocate a transmission time slot for each VLC device;
wherein, for each VLC device, at least one of the optical sources is configured to transmit data to the VLC device during the time slot allocated to the VLC device, the at least one optical source being part of a cell associated with the VLC device;
wherein the VLC coordinator is configured to:
provide a contention access period for each VLC device in the macrocell to connect to the VLC coordinator; and
provide a plurality of cell search time slots in the superframe to search for VLC device locations, wherein during each cell search time slot, only one cell of the macrocell is enabled for communication at a given time.

17. The VLC coordinator of claim 16, the VLC coordinator configured such that, during each of a plurality of cell search time slots:
at least one of the optical sources is configured to transmit at least one visibility frame at a cell associated with the cell search time slot;
at least one photodetector is configured to receive a response comprising a visibility frame from a VLC device in the cell associated with the cell search time slot; and
the DME is configured to determine that the VLC device is located in the cell in which the response from the VLC device was received.

18. The VLC coordinator of claim 16, wherein the macrocell comprises an aggregate cell comprising all of the optical sources.

19. The VLC coordinator of claim 16, wherein the number of cell search time slots is determined according to a value in a cellSearchLength field in the beacon frame.

20. The VLC coordinator of claim 16, wherein the transmission time slot allocated to each VLC device is part of a contention free period (CFP) in the superframe.

21. The VLC coordinator of claim 16, wherein the data is transmitted to each VLC device based on a SW-BIT-MAP vector, each bit in the SW-BIT-MAP vector corresponding to a distinct optical source.

22. The VLC coordinator of claim 21, wherein the SW-BIT-MAP vector is a n×m vector, where n is a number of cells and m is a number of distinct data streams.
